(19) United States
(12) Patent Application Publication
(10) Pub. No.: US 2013/0225295 A1
(43) Pub. Date: Aug. 29, 2013

(54) METHODS AND/OR SYSTEMS FOR CONTROLLING VIRTUAL OBJECTS

(71) Applicant: Yoonjoon Lee, Redmond, WA (US)

(72) Inventor: Yoonjoon Lee, Redmond, WA (US)

(73) Assignee: NINTENDO CO., LTD., Kyoto (JP)

(21) Appl. No.: 13/405,133

(22) Filed: Feb. 24, 2012

(51) Int. Cl. A63F 13/00

(52) U.S. Cl. 463/37

(57) ABSTRACT

A computer generated object is controlled through the use of two inputs. One of the inputs is based data from a motion sensor. In certain instances, the motion sensor is a gyro sensor. The two inputs may be combined to determine an attribute of the computer generated object which is then animated in accordance with the determined attribute.

### CROSS-REFERENCES TO RELATED APPLICATIONS

### Statement Regarding Federally Sponsored Research or Development

### Field

The technology herein relates user input techniques for affecting virtual objects that are displayed by a computer system. In particular, the technology herein relates to using inputs, at least one of which is a motion sensor, for controlling a characteristic of a virtual object.

### BACKGROUND AND SUMMARY

Since the early years of computing user input schemes have progressed to increasingly more flexible systems. For example, users can use a mouse and keyboard to interact with a personal computer or can use a game controller to interact with a game system. In more recent years, touch screen displays, such as the Nintendo DS and the iPad, have emerged and provided the ability for users to input commands through a touch screen. However, while these devices may be relatively efficient in allowing a user to provide input to a computer, they can present challenges for controlling and displaying some types of virtual object.

For example, a user playing a golf game may use a mouse or stylus to swing a golf club by performing a series of clicks or one or more touches. However, using a mouse or touch screen to swing a virtual golf club may not provide a user with much immersion in the golf game being played. This may be because slightly moving a mouse on a surface or touching a screen does not resemble very well how a golf club is swung in real life.

Certain user input devices have sought to address this lack of immersion in the virtual world. In particular, one area that has seen much interest has been tilt or motion sensing.

Motion sensors can detect various aspects of movement applied to a housing (e.g., a controller or portable game system). For example, an acceleration sensor can be used to detect acceleration (i.e., a force).

In the late 1990's Nintendo released a game called “Kirby Tilt ‘n’ Tumble” for the Game Boy handheld platform. The game included a game cartridge containing an accelerometer that was used to detect “tilt” of the handheld in which the cartridge was connected. The display provided a pinball machine like scenario where a ball (“Kirby”) rolled based on the “tilt” detected by the accelerometer. Users could also use other inputs (e.g., the “D-pad”) to control various aspects of gameplay.

Other games have used buttons and tilt or motion sensing together. For example, “WarioWare: Twisted!” for the Nintendo's Game Boy Advance platform Included a cartridge with a built-in gyro sensor. Other games have used motion sensing to control, for example, the attitude of an airplane along with user depressible buttons to, for example, control weapon firing. Nintendo's Wii Remote also uses an acceleration sensor to give a user an exciting way to provide input.

A user can perform various motions that can be reflected in the virtual world when using a motion sensor. For example, a user can perform a golf swing and have the detected accelerations trigger corresponding animations in a golfing game. Such an experience can increase the level of enjoyment and/or immersion that the user experiences in playing a game.

Certain handheld game devices can also include motion sensors. The Nintendo 3DS handheld platform provides, cross switches, a touch screen, push buttons, and a circle pad. The circle pad, which is described in U.S. Publication No. 2011/0304707, the entirety of which is hereby incorporated by reference, provides a circular surface that a user can operate with a thumb while holding handheld device in one or both hands. Also, the device includes a gyro sensor or accelerometer that detects tilt or motion of the device. This sensed data can then be used to control gameplay simultaneously with input from other analog controls (e.g., the circle pad). While certain capabilities of the 3DS are known through its commercial release (from its March 2011 release date in the United States), the particular manner in which a traditional input (e.g., the circle pad or d-pad) interacts with tilt or motion sensing is not predetermined.

Thus, more work in this area is useful and desirable to achieve more intuitive, immersive, and/or useful user interfaces. Accordingly, an area worthy of further exploration and development relates to simultaneous use of multiple inputs by a user, some of which are motion sensing and some of which are digit activated (e.g., a button), to affect a virtual object. In particular, some applications could provide interaction between motion or tilt sensing and other user input on the same handheld device.

In certain example embodiments, a character control scheme for a video game is provided that uses a control pad along with a motion sensor such as, for example, a gyro sensor in one intuitive control scheme. Input provided from these two input devices may be sensed together and used to control a video game character or a characteristic of the video game character.

Certain example embodiments may provide one or more of the following advantages:

1) Bring new and more intuitive ways of control by uniquely combining a control pad and a motion sensor (e.g., a gyro sensor) together at the same time.

2) Provide a player control scheme that is more intuitive for users to understand and adopt. Such a scheme may also be beneficial to casual users who may not be as adept at using conventional control schemes.

The following are illustrative, non-limiting examples.

1) A user controls a character with a control pad. However, by tilting a portable game device in the opposite direction the character is moving, the character slows down. This may allow more time for a user to react to in-game situations. Correspondingly, when the portable game device is tilted in the same direction as the direction indicated on the control pad, the character may accelerate. This may allow the character to, for example, jump a longer distance.

2) A user controls a character holding a fishing pole. By tilting back (e.g., rotating) and also performing a circular motion on a control pad (e.g., a touch pad) the user may simulate a fishing motion while reeling in a caught fish.

3) A user controls a tank in a game. Input from a gyro sensor in a controller (or the body of a portable game device) may provided independent control over a gun turret of the tank while movement of the tank (e.g., via the tracks on the tank) may be provided by a control pad.

4) A user controls a virtual character that is performing a balancing act. The control pad provides directional movement that allows the virtual character to, for example, turn to the right. A gyro sensor is provided and is used to counter-balance the inertia of a character that is changing direction. The force applied to the virtual character may then be the sum of the force cause by the control pad and that provided by the gyro sensor.

In certain example embodiments, a method for controlling a computer generated object is provided. First input data is received from a first control. Second input data is received from a motion sensor that senses motion applied to a housing that has a form face to be held by at least one hand of a user. A value of an attributed that is associated with the computer generated object is determined, the value being based on the first input and second input. The computer generated object is animated based on the determined value of the attribute and displayed to the user via a display.

In certain example embodiments, a video game apparatus for controlling a computer generated object based on user provided input is provided. The apparatus includes a processing system that is configured to receive first and second input data where the second input data is from a motion sensor configured to sense motion applied to a housing that has a form factor designed to be held be at least one hand of the player. A value of an attribute that is associated with the computer generated object is determined. The value is based on the first and second inputs. The object is animated based on the attribute and output to a display screen for display.

In certain example embodiments, a non-transitory computer readable storage medium is provided. The medium includes instructions for controlling a computer generated object based on user input. First and second input data are received where the second input data is from a motion sensor configured to sense motion applied to a housing that has a form factor designed to be held be at least one hand of the player. A value of an attribute that is associated with the computer generated object is determined. The value is based on the first and second input data. The object is animated based on the attribute and output to a display screen for display.

Certain example embodiments herein relate to techniques for controlling a virtual object that is processed by a computing system. The control of the virtual object may be provided through two different inputs. In certain example embodiments, one of the inputs is provided in the form of a motion sensor such as, for example, a gyro sensor. In certain example embodiments, one of the inputs is used to counter balance the other provided input. Based on the provided inputs a graphical object is animated or displayed to a user.

### BRIEF DESCRIPTION OF THE DRAWINGS

These and other features and advantages will be better and more completely understood by referring to the following detailed description of exemplary non-limiting illustrative embodiments in conjunction with the drawings of which:

FIGS. 1A-1C show a user controlling a virtual character on an exemplary non-limiting portable computing system;

FIG. 2 shows an example of a combined user input technique using an exemplary non-limiting portable computing system;

FIG. 3 is another illustration of how the combined user input technique from FIG. 2 relates to control of the virtual object;

FIG. 4 shows a flow chart for implementing an example combined user input technique; and

FIG. 5 shows an exemplary computing system for processing a combined user input technique.

### DETAILED DESCRIPTION

Snowboarding is a popular wintertime activity for many people. However, proper winter conditions are not always available for a person to enjoy the thrill of cruising down the slopes. Video games can offer an outlet for people to enjoy some of the experiences that may be tied to the “real thing,” and without the requirement of locating snow or driving to a nearby mountain.

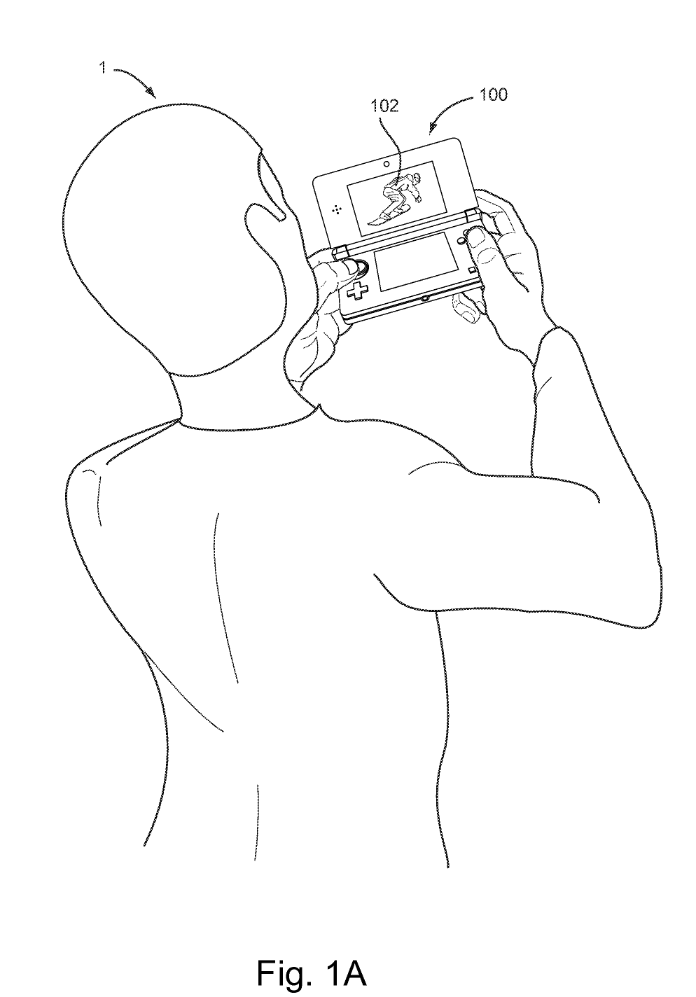

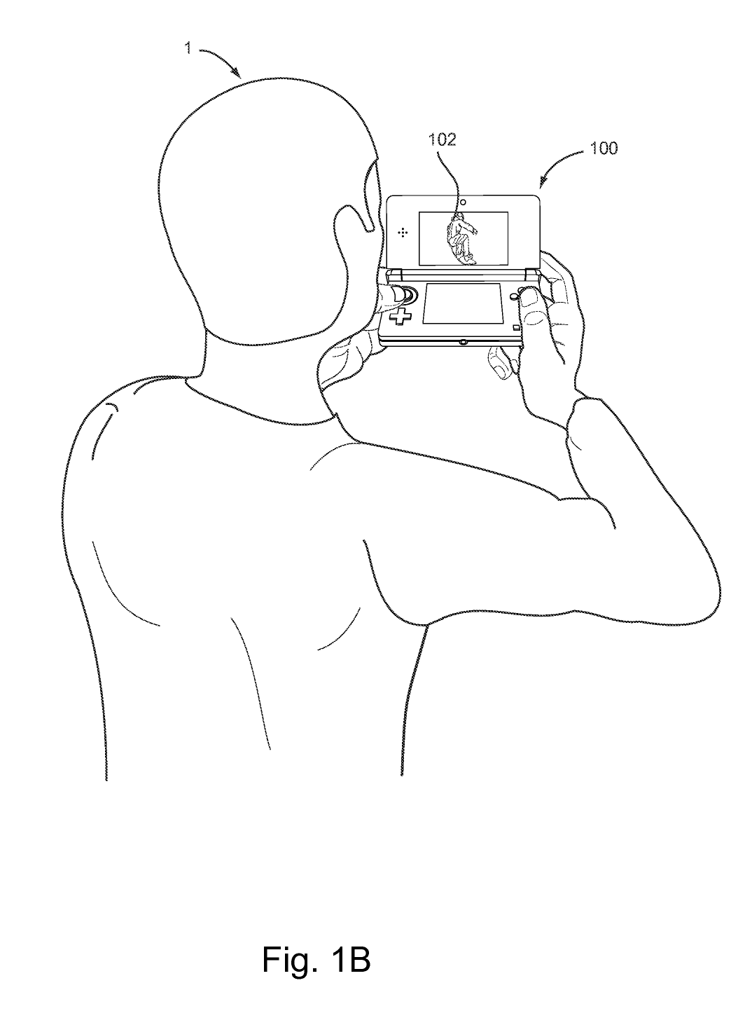

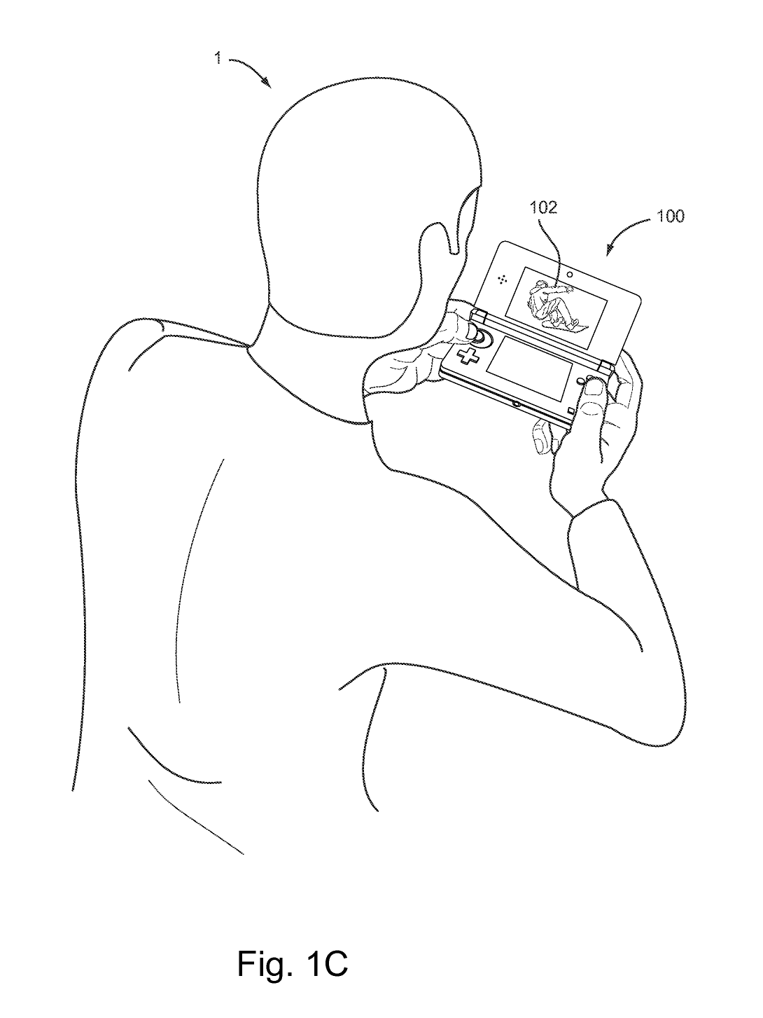

In this respect, a user 1 is shown in FIGS. 1A-1C controlling a virtual snowboarder 102 on an example portable computing system 100.

In FIG. 1A the user 1 is shown leaning to the left while pressing a joystick control to the right with his left hand. Further, when the user 1 leans to the left, the portable computer system 100 is also titled to the left. As explained herein, such a tilt may sensed and provide input to a game (e.g., a snowboarding game) to “counter-act” another game force such the force applied from the game character turning to the right. Based on input from the joystick control and a motion sensor, the virtual snowboarder 102 is shown turning to the right.

In FIG. 1B, the user 1 is shown in an upright position (with the portable game system likewise being no longer tilted) with the joystick control centered. Responsive to these inputs, the snow boarder is shown proceeding in a generally straight direction.

Subsequently, in FIG. 1C's illustrative example, the user 1 is shown tilting to the right (and thus tilting the portable computing device 100 to the right) while moving the joystick control to the left. Such inputs may cause the virtual snowboarder 102 to make a left turn.

Thus, input provided to the computing system 100 may be provided by the user 1 through a standard gameplay input (e.g., a joystick or a button) and/or input provided via a motion sensor (e.g., an acceleration or tilt sensor).

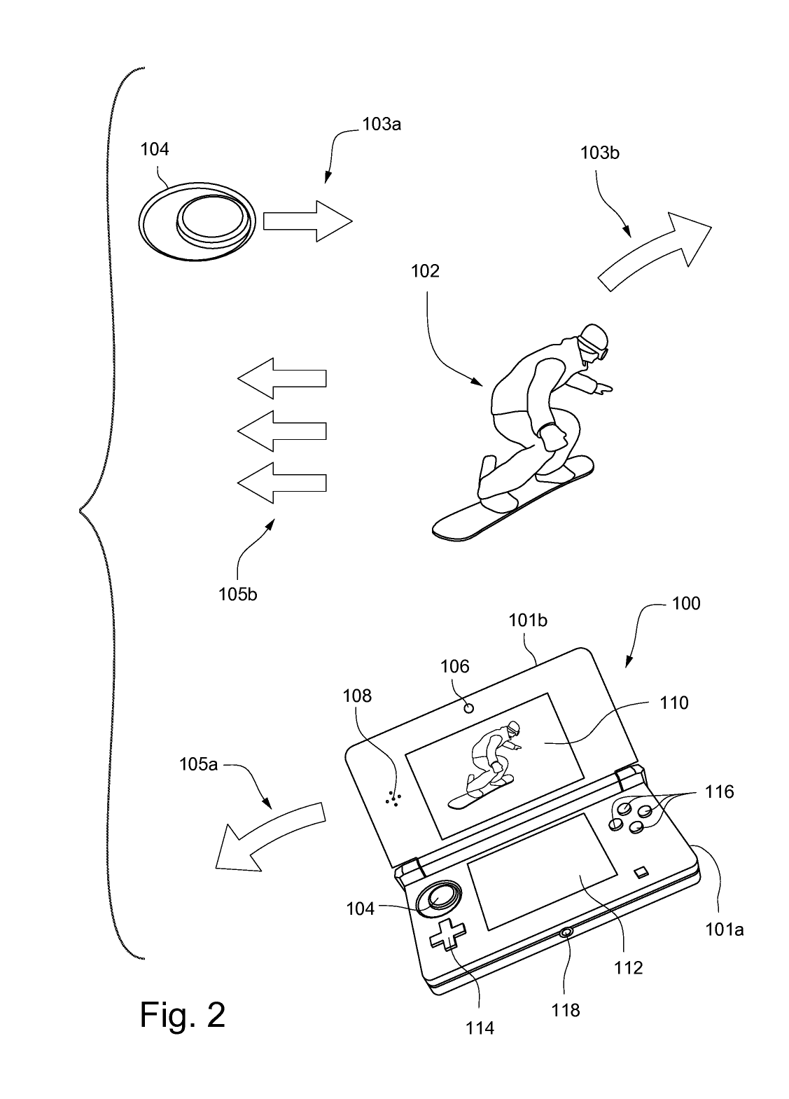

FIG. 2 shows a more detailed illustration of how a portable game device controls a virtual character. Here, the snowboarder is shown snowboarding down a mountain and the user is responsible for controlling how the snowboarder moves in the game. Based on user provided input the game may animate/move the snowboarder in different ways. For example, the user may provide input to turn the snowboarder through a series of gates (e.g., turning right, left, right again, etc) to achieve the best time.

The example portable gaming device 100 includes a foldable housing with a lower portion 101a and an upper portion 101b. LCD screens 110 and 112 are respectively disposed in the housings of the upper 101b and lower 101a portions of the portable game device 100. In certain example embodiments, one or both of the LCD screens 110 and 112 may be associated with a touch panel (e.g., touch screens) that accepts input from a user. A circle pad 104, a D-pad 114, and buttons 116 may be provided on the lower portion 101a. In certain example embodiments, different controller inputs may be included on the upper and/or lower portions of the game device. In certain instances, only the circle pad or touch input may be provided (e.g., buttons 116 may not be present). It will be appreciated that other inputs may be added and/or removed.

The portable game device 100 may also include a camera 106. In certain example embodiments, two or more cameras may be provided and may allow for movement tracking or three-dimensional pictures. In certain example embodiments, such movement tracking may function as an input similar to how a motion sensor is used as input (e.g., tracking user movement to the left may correspond to tilting the game device). The upper portion 101b may also include speakers 108 that output sound for a user. An interface for connecting a sound input and/or output device 118 (e.g., microphone or headphones) may also be provided on the lower portion 101a.

It will be appreciated that other types of portable or handheld devices may be used in relation to certain example embodiments. For example, a tablet type device in which substantially all of a major surface area is a touch screen display may be used. In such cases, input provided from a user to the touch screen may be combined with motion or tilt sensing data from a sensor. Certain embodiments may include a single LCD screen or more than two LCD screen.

In certain example embodiments, the computing device may be designed to be stationary. For example, the computing device may be a personal computer or a stationary console that accepts input from two or more controller inputs. Example controllers may include a mouse, a keyboard, a joystick, etc. In certain instances the use of such controllers may correspond to the functionality of the inputs provided on the portable gaming device 100 (e.g., circle pad 104).

Additionally, a controller may include a motion sensor (e.g., a two or three-axis accelerometer and/or a gyro sensor) and provide sensed data to the computing system for processing. Thus, separate handheld controllers may communicate with a stationary console or PC to provide input. In certain example embodiments, an analog user-operable input control and a motion sensor may be provided in separate housings that are respectively designed to be held in each hand of a user.

Returning to FIG. 2, the portable gaming device 100 displays the virtual snowboarder 102 on LCD screen 110. Alternatively, or in addition, the display of a player character may be on LCD 112.

Directional control of the snowboarder may be provided via circle pad 104 such that when the circle pad is moved (or biased) to the right 103a the snowboarder correspondingly turns or moves right 103b in the virtual game world. This functionality may operate similar to that of a traditional joystick or other input device (e.g., D-pad 114). In certain example embodiments, such input may come from a touch input device (e.g., a touch screen)

However, in certain instances, moving the circle pad 104 all the way to the right 103a, as shown in FIG. 2, may cause the snowboarder to lean too far to the right, overbalance, and fall down. To avoid this, traditional games may allow a user to slightly adjust a joystick control so that it is not completely at the extent of the right hand movement of the pad. In other words, instead of being 100% to the right, the controller may be 75% to the right. Such a position may correspond to a less severe turning motion, and accordingly the in-game snowboarder 102 may avoid a loss of balance.

However, in the example shown in FIG. 2 another component may be applied to “counter” the force resulting from movement of the circle pad. Such a counter balancing force may assist in preventing the snowboarder 102 from falling during gameplay.

In particular, a force may be determined or calculated based on information provided from a motion sensor in the portable game device. For example, a user of the portable game device 100 may tilt the device to the left 105a. As a result of this motion, a motion sensor associated with the portable game device 100 may detect the applied motion or tilt and provide the detected data to a processor. The detected data may then be used to determine how much of a counter-balancing force should be applied to the snowboarder 102. Thus, force 105b may act in an opposite direction from the force related to 103b.

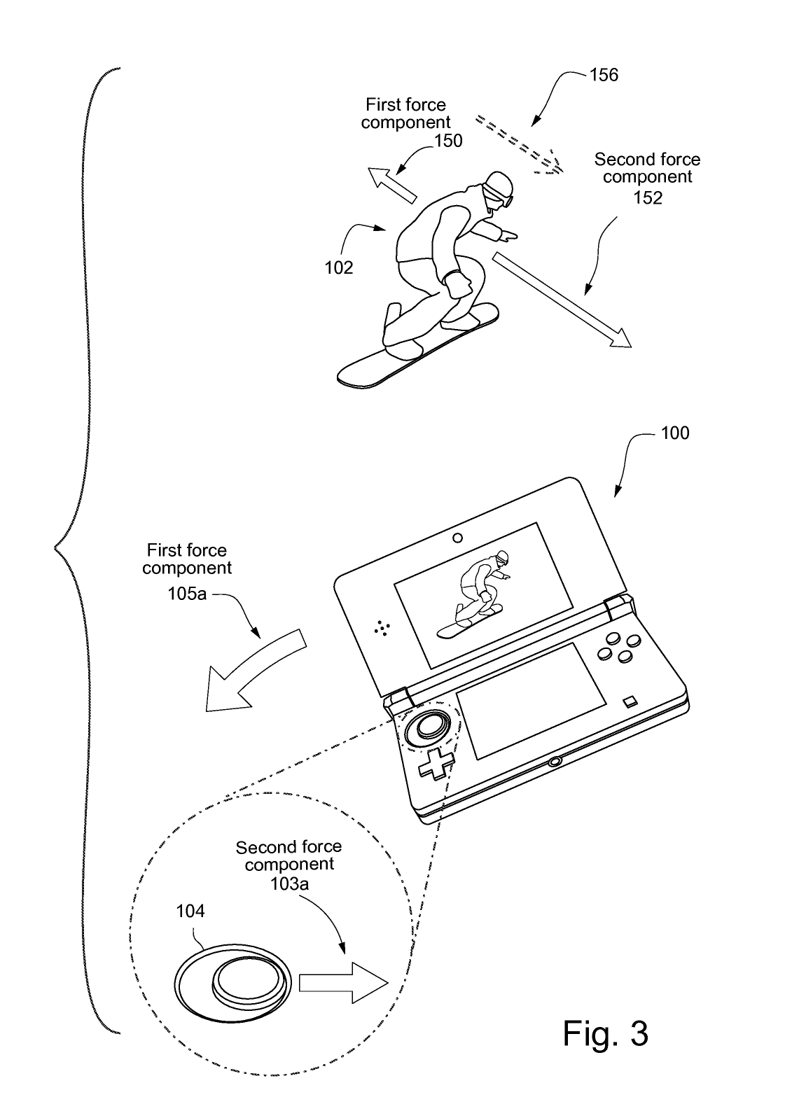

FIG. 3 is another illustration of the snowboarder 102 and the input that may be provided via the circle pad 104 and the motion sensor in the portable game device 100. In particular, FIG. 3 illustrates an example relationship between the real-life “force” (e.g., tilt, movement, acceleration, etc) that is associated with the user input and the virtual force applied to the virtual object.

For example, shifting the circle pad 104 to the right 103a may be associated with a real-world physical action. This physical action may then be translated to second “virtual” force component 152 that is applied to the virtual snowboarder 102. Correspondingly, as explained above, the portable game device may also be subjected the physical action of “tilting.” The value(s) measured by the action may then be converted into a first force component 150 that is applied to the virtual snowboarder 102. In certain example embodiment, the sum of these two opposing forces (150 and 152) may be 156. Thus, the virtual snowboarder may turn to the right based on the value of “force” 156.

In certain example embodiments, a maximum amount of force that may be applied based on user input from a joystick, circle pad etc, may be first maximum value. In contrast, the maximum amount of force that may be applied based on data sensed from a motion sensor may be a second maximum value that is less than the first maximum value. In other words, the force applied to the snowboarder 102 in FIG. 2 from movement of the circle pad may be the “main force,” while the force derived from the motion data based on the tilting of the portable game device 102 may be smaller or secondary force. Such a force may then be the balancing force that is applied against the larger, main force.

In certain example embodiments, input from a first controller, such as the circle pad 104, may provide input that is combined with data from a motion sensor. In such implementations, the maximum contribution that a motion sensor may provide to a final combined value may be 25% of the maximum that the first controller may provide. As an example, the motion sensor may influence the speed of an object by up to 1 meter per second whereas the first controller may influence the speed of the object by up to 4 meters per second. It will be appreciated that such values are given by way of example and that other percentages and values are contemplated (e.g., a maximum may be between 0% and 200% of the maximum value of the first input).

Thus, when the circle pad 104 is shifted all the way to the right (e.g., 4 meters per second), and the motion sensor detects motion that relates to a maximum value (e.g., 1 meter per second) the final combined value that may be applied to an object being processed by the computing system may be equivalent to 75% of the maximum value of the first controller (e.g., 3 meters per second).

In certain instances, the effect force or movement that is based on a motion or tilt sensor may be relatively small. In such instances, the results of moving a housing with the sensor may not be overly visible to the user. For example, a user holding a portable device playing a snowboarding game may unconsciously move in correspondence with the action of a displayed snowboarder. Indeed, in certain instances, the input provided via a motion sensor may capture some or all of a user's reflexive physical motions when playing the game. Such input may then be translated into gameplay input. Thus, the effect of tilting the device may be relatively minor, but still enough to influence the movement or force applied to a user controlled player character.

In certain example embodiments, values derived from a motion sensor may also be added (as opposed to subtracted) to those values from another input. Thus, taking the above example, shifting the circle pad all the way to the right in addition to having the portable device tilt to its maximum may result in a final combined value of 5 meters per second (as opposed to the maximum of 4 m/s with just the circle pad). Thus, values based on a motion sensor may be additive and/or subtractive based on the relative (or absolute) directions of motion.

As a gameplay example, a player character running along in accordance a circle pad direction (e.g., to the right) may increase their speed for a short time (e.g., sprint) when the user turns or accelerates the motion sensor in the direction of the virtual motion of the game character.

Correspondingly, turning the device against the direction of motion may cause the player character to slow down. This may allow, for example, a user more time to react to gameplay that is being displayed on a game screen. For example, if the character part of dungeon style gameplay that requires timing jumps or precise character placement to pass a level.

In certain example embodiments, the relationship of the values used in gameplay and the raw data detected may be linear in nature. In other words, each angle of tilt may correspond to some percentage of change in the game play value (e.g., meters per second). In certain example embodiments, the relationship between an amount of tilt or movement and game play values may be exponential or some other functional relationship (e.g. logarithmic).

In certain example embodiments, a detected motion may have a floor or ceiling on the corresponding gameplay value. For example, a tilt between 1 and 5 degrees may correspond with the lowest non-zero gameplay value while a 20 degree tilt may be associated with a maximum gameplay value. In other words, tilting beyond 20 degrees may not yield larger (or lesser) corresponding game play values.

FIG. 3 shows a flow chart for implementing an example combined user input technique. In step 202 a player controlled object is displayed to a user. A user provides input to a computing system in steps 204 and 206. The inputs are of two different types. As discussed above, a first input may be from, for example, a circle pad while a second input may be based on detected motion sensor information (e.g., a gyro sensor).

After receiving the raw data from the first and second input, the data may be translated in values that can be used for gameplay (e.g., gameplay values). In certain example embodiments, the values from these respective inputs may be combined into a final value.

In step 208, processing may be performed to animate the player controlled object based on the values derived from the various inputs. This animation may reflect the character moving at a certain speed or an update of the characters position within a virtual game world (e.g., as a character runs from one location to another). Once the animation is performed by a processor on the computing system, the resulting display of the game may be output to a display in step 210 to be seen by the user.

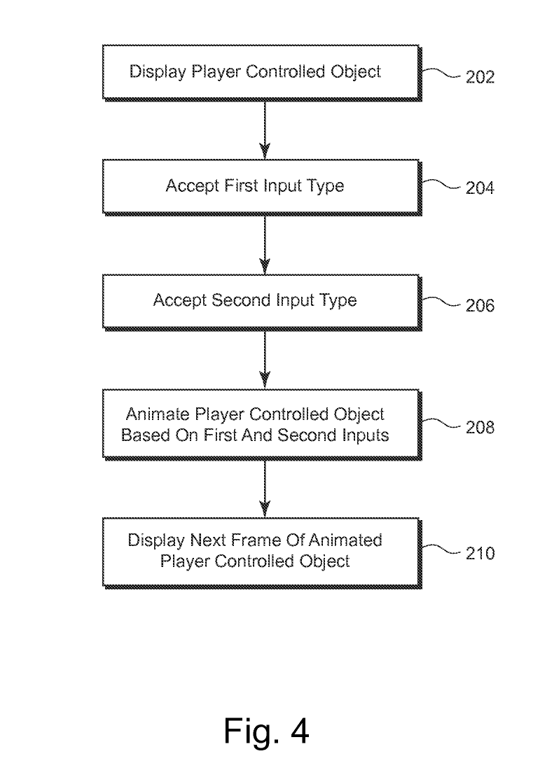

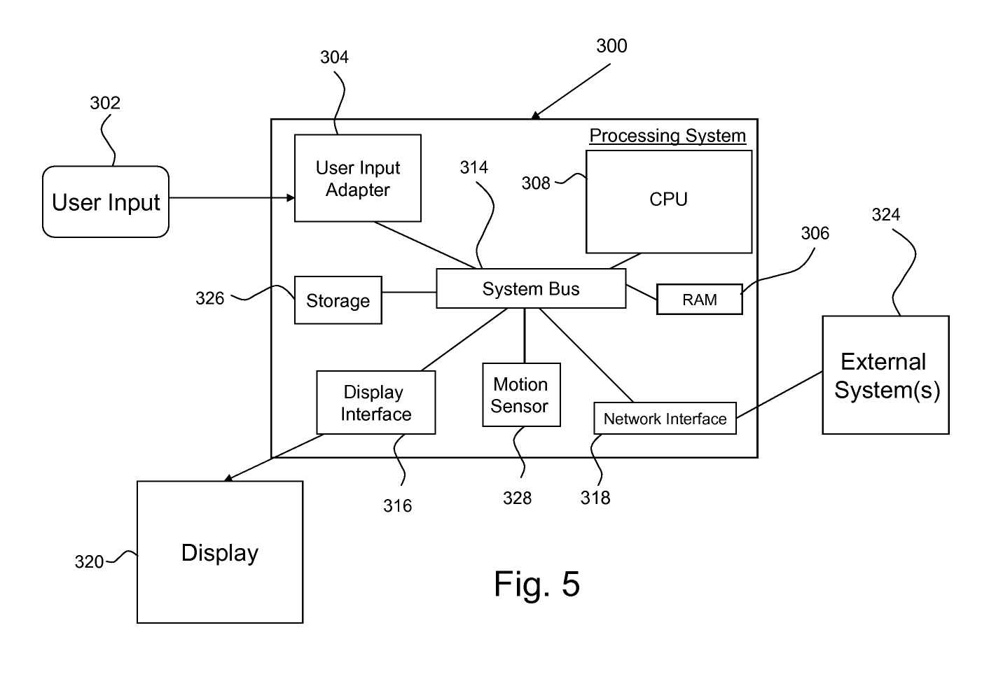

FIG. 4 shows an exemplary computing system. A processing system 300 includes a user input adapter 304 that communicates with a user input device 302. As discussed herein, the user input device may be part of a portable game device (e.g., as shown in FIG. 1) or may communicate with a stationary game device (e.g., a person computer or console). In any event, the user input adapter may communicate the provided input to a system bus 314. The input may be stored in RAM 306 (e.g., volatile memory) and/or operated on by CPU 308. Input may also be sent to storage 326 to be saved and “replayed” at a latter time on the processing system. The processing system may also include a motion sensor 328. As with the input provided from the user input device 302, input from a motion sensor may be sent to RAM 306, CPU 308, and/or Storage 326 (e.g., to be recorded for playback at a later time).

Processing system 300 may also include a display interface 316 that is adapted to communicate with a display 320. The display 320 may be a television set or an LCD screen within a portable game device. Processing system 300 may also include a network interface 318 that communicates with external system 324. The external systems 324 may include offline storage or databases, other game devices or systems for multi-player support, etc.

While certain example embodiments have been described with reference to one plane of rotation (e.g., left/right), other embodiments may include more than one plane of rotation. In other words, a user may tilt backward/forward, go forward/backward, and/or a combination thereof, etc and have the sensed motion be reflected in the input used to control a virtual object.

In certain example embodiments, the motion sensor may be external to the main processing system. For example, the motion sensor may be provided in a controller that is held by a user.

In certain example embodiments, a motion sensor may include a camera system that records or otherwise detects movement by a user.

In certain example embodiments, a visual indicator of input provided from a first input (e.g., a circle pad) and input from a motion sensor may be provided. For example, a bar that indicates the balance of the character may be shown to a user. The bar may change color or flash when the user is about to lose his balance. Such an indication may provide feedback to a user as to when a counter-balancing force may be applied in order to prevent the player character from crashing or the like. In certain instances, an animation could be provided (e.g., the snowboarder shakes—indicating that he is loosing his balance). Such visual queues may useful for users during gameplay.

U.S. Pat. No. 7,942,745; U.S. Publication Nos. 2007/0049374, 2009/0278764, 2010/0007528, 2011/0190052, 2011/0190061; and U.S. application Ser. No. 13/267,233 are each, in their entirety, hereby incorporated by reference.

While certain example embodiments are described in relation to video games, it will be appreciated that the techniques herein may also be applied to computer interfaces in general. For example, cursor movement or menu selection may be performed with first and second input types.

It will be appreciated that as used herein, terms such as system, subsystem, service, programmed logic circuitry, and the like may be implemented as any suitable combination of software, hardware, firmware, and/or the like. It also will be appreciated that the storage locations herein may be any suitable combination of disk drive devices, memory locations, solid state drives, CD-ROMs, DVDs, tape backups, storage area network (SAN) systems, and/or any other appropriate tangible computer readable storage medium. It also will be appreciated that the techniques described herein may be accomplished by having a processor execute instructions that may be tangibly stored on a computer readable storage medium.

The above description is provided in relation to embodiments which may share common characteristics, features, etc. It is to be understood that one or more features of any embodiment may be combinable with one or more features of other embodiments. In addition, single features or a combination of features may constitute an additional embodiment(s).

While the technology herein has been described in connection with exemplary illustrative non-limiting embodiments, the invention is not to be limited by the disclosure. The invention is intended to be defined by the claims and to cover all corresponding and equivalent arrangements whether or not specifically disclosed herein.

We claim:

1. A computer-implemented method for controlling a force that is applied to a virtual player object that is represented in a virtual world processed via a processing system that includes at least one processor, the method comprising:
receiving first input data from a first input control that is controlled by a player;
receiving second input data from a motion sensor that is configured to sense motion applied to a housing that has a form factor designed to be held be at least one hand of the user;
calculating a first value based on the first input data;
calculating a second value based on the second input data;
determining, via the processing system, a virtual force applied to the virtual player object, the virtual force based at least on the first input and the second input;
animating the virtual player object based on the determined virtual force; and
outputting the virtual player object to a display screen.

2. The method of claim 1, wherein the motion sensor is an acceleration sensor and/or a gyro sensor.

3. The method of claim 1, wherein the first input control is selected from a group that consists of a control pad, a joystick, a depressible button, a circle pad, and a touch screen display.

4. The method of claim 1, wherein the second value is smaller than the first value.

5. The method of claim 1, wherein the virtual force is associated with a balance of the virtual player object.

6. The method of claim 1, further comprising:
summing the first value with the second value to obtain the virtual force.

7. The method of claim 1, wherein:
the first input data is associated with a first direction of the virtual player object, and
the second input data is associated with a second direction of virtual player object, the second direction being at an angle that is obtuse to the first direction.

8. The method of claim 1, wherein the second input data counterbalances the first input data.

9. The method of claim 1, wherein the method is performed within a frame of a video game.

10. A video game apparatus for controlling a computer generated object based on user provided input, the apparatus comprising:
a processing system that includes at least one processor, the processing system configured to:
receive first input data from at least one user input control that is configured to be actuated a user of the video game apparatus;
receive second input data from a motion sensor that is configured to sense motion applied to a housing that has a form factor designed to be held be at least one hand of the player;
calculate a first value based on the first input data;
calculate a second value based on the second input data;
determine a force value of the computer generated object based on at least on the first value and the second value;
animate the computer generated object based on the determined force value; and
output the computer generated object to a display screen.

11. The apparatus of claim 10, wherein:
the processing system is disposed within the housing;
the motion sensor disposed on/in the housing and configured to communicate with the processing system; and
the at least one input controller is disposed on the housing.

12. The apparatus of claim 10, wherein the housing is physically separate from the video game apparatus and includes the at least one input controller.

13. The apparatus of claim 10, wherein the motion sensor includes a gyro sensor and/or an acceleration sensor.

14. The apparatus of claim 10, wherein the second value counter balances the first value.

15. The apparatus of claim 10, wherein the combination is determined by a summation of the first and second values.

16. A non-transitory computer readable storage medium storing computer readable instructions for controlling a computer generated object in a virtual world based on user provided input, the storage instructions comprising instructions configured to:
receive first input data from at least one input controller that is configured to be actuated a user of the video game apparatus;
receive second input data from a motion sensor that is configured to sense motion applied to a housing that has a form factor designed to be held be at least one hand of the player;
calculate a first value based on the first input data;
calculate a second value based on the second input data;
determine a value of a movement attribute of the computer generated object, the value based at least on the first value and the second value;
animate the computer generated object based on the determined value of the movement attribute; and
output the computer generated object to a display screen.

17. The medium of claim 16, wherein the motion sensor is an acceleration sensor and/or a gyro sensor.

18. The medium of claim 16, wherein the value of the movement is less than the first value.

19. The medium of claim 16, wherein the second value has a maximum value that is less than a maximum value of the first value.
